(19) United States
(12) Patent Application Publication
(10) Pub. No.: US 2012/0145526 A1
(43) Pub. Date: Jun. 14, 2012

(54) MOVABLE CONTACT FOR SWITCHING

(76) Inventor: Masazi MASUDA, Shizuoka-shi (JP)

(21) Appl. No.: 13/287,229

(22) Filed: Nov. 2, 2011

(30) Foreign Application Priority Data
Dec. 10, 2010 (JP) 2010-275304

(51) Int. Cl. H01H 1/10

(52) U.S. Cl. 200/513

(57) ABSTRACT

The invention prevents a dome-shaped movable contact for switching from being deformed beyond necessity, and also prevents a contactor from being poorly recovered in advance. The movable contact for switching comprises a reversely recoverable contactor formed by curving an electrically conductive leaf material into a dome-like shape while forming a bulge at the center of a convex surface of the contactor, the bulge protruding toward a dome-shaped convex side, a plurality of contact points formed by forming small projections concentrically positioned around the bulge, on a concave surface of the contactor, the small projections protruding toward a dome-shaped concave side, and a recess for use in prevention of deformation, on a convex side face of the bulge, formed by depressing a part of the circumference of the bulge, on a straight line connecting the center of the bulge with each of the contact points, toward the center.

This application claims priority from Japanese Patent Application No. 2010-275304, filed on Dec. 10, 2010, the entire contents of which are herein incorporated by reference.

### BACKGROUND

1. Technical Field

The invention relates to a switch built in signal input sections of various equipments, particularly, to an improvement of a dome-shaped movable contact for switching having a click function.

2. Related Art

A patent document 1 discloses a dome-shaped movable contact for switching of this type. The movable contact for switching has a cylindrical projection formed at the center of a dome-shaped contactor. In such a conventional movable contact for switching, if a high load, for example, a static load of 10 Kg is applied for 1 minute, a static load of 20 Kg is applied for 5 seconds or a static load of 40 Kg is applied for 1 second, respectively to the cylindrical projection formed at the center of the movable contact, the cylindrical projection is deformed in flat, thereby rendering the entire dome-shaped movable contact to deform in a direction to expand a diameter (hereinafter referred to as a diameter expansion direction) so as to bulge outward, resulting in the occurrence of a phenomenon wherein the movable contact for switching is not recovered to its original state, namely, poor recovery has occurred.

Particularly, in the case where a circumference of the cylindrical projection is formed by a gentle curved surface and small contact points in the shape of small projections which contact fixed contacts are formed in the circumference of the cylindrical projection, when the movable contact for switching is formed in a diameter expansion direction upon receiving a high load, it is largely deformed about the contact points in the shape of small projections serving as fulcrums beyond a reversely recoverable limit, so that poor recovery is frequently occurred.

### Related Art Literature

[Patent Document] JP 2000-322974 (corresponding to U.S. Pat. No. 6,271,491B1 patented Aug. 7, 2001)

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any disadvantages.

It is one of illustrative aspects of the invention to prevent a dome-shaped movable contact for switching from being deformed beyond necessity, and also prevent a contactor from being poorly recovered in advance.

According to one or more illustrative aspects of the invention, there is provided a movable contact for switching comprising a reversely recoverable contactor formed by curving an electrically conductive leaf material into a dome-like shape while forming a bulge at the center of a convex surface of the contactor, the bulge for addition of rigidity, protruding toward a dome-shaped convex side, a plurality of contact points formed by forming small projections concentrically positioned around the bulge, on a concave surface of the contactor, the small projections protruding toward a dome-shaped concave side, and a recess for use in prevention of deformation, on a convex side face of the bulge, formed by depressing a part of the circumference of the bulge, on a straight line connecting the center of the bulge with each of the contact points, toward the center.

### BRIEF DESCRIPTION OF THE DRAWINGS

FIG. 1 is an enlarged plan view of a movable contact for switching according to the invention;

FIG. 2 is an enlarged side view of the movable contact for switching according to the invention, partly in cross section, the cross section corresponding to a half cross section taken along the arrow A in FIG. 1;

FIG. 3 is an enlarged side view showing an operation state of the movable contact for switching according to the invention, partly in cross section, the cross section corresponding to a half cross section taken along the arrow A in FIG. 1;

FIG. 4 is a view for explaining an operation and an effect of a recess of the movable contact for switching according to the invention; and

FIGS. 5(1) to 5(3) are plan views of bulges and recesses of a movable contact for switching according another embodiment of the invention.

### DETAILED DESCRIPTION OF EXEMPLARY EMBODIMENTS

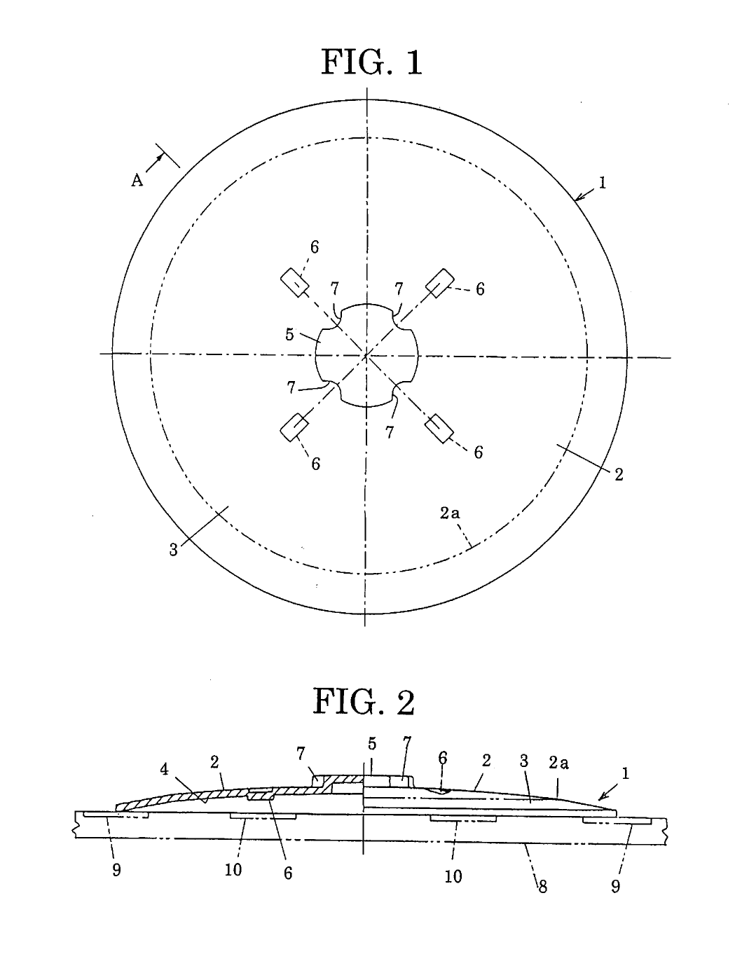

In FIG. 1 and FIG. 2, a movable contact for switching 1 of the invention is structured as a reversely recoverable contactor 2 by curving a substantially circular conductive leaf material into a dome-like shape. The conductive leaf material is made up of, e.g. a circular stainless steel plate plated with silver or nickel and having a thickness in the order of 0.04 to 0.1 mm, and a size in the order of 3 to 6 mm in diameter if it is an operation switch of a cell phone. Meanwhile, the contactor 2 is not limited to the circular conductive leaf material but it can be made up of a conductive leaf material in an appropriate shape, depending on a subject in which it is built, e.g. in the shape of an oval, a rhombus, a rectangle or a conductive leaf material in the shape wherein corners of the rhombus, the rectangle are cut down by an arc or a straight line.

The contactor 2 has a bulge 5 formed by drawings in the shape of frustum of a cone, the bulge 5 protruding toward a dome-shaped convex side at the center of a convex surface 3 thereof. A plurality of contact points 6 are formed by forming small projection concentrically positioned around the bulge 5, on a concave surface 4 of the contactor 2, the small projections protruding toward a dome-shaped concave side. A circular two-dotted chain line of the contactor 2 indicates ridgeline 2a of different curved surfaces of the contactor 2, and the ridgeline 2a serves as a bending line when the contactor 2 executes a reverse operation.

The bulge 5 is formed to have a size necessary for adding rigidity to a central portion of the contactor 2 and receiving an external force such as a load or an operation force at the central portion of the contactor 2, so that it can be formed in the shape of a frustum of an ellipse, a rectangle, and a polygon as well as a frustum of a cone. The contact points 6 can be formed by drawing but it is preferably formed by cutting about one third of a thickness of the material by half die cutting (half-cut process). The contact points 6 are formed, as an example, at 90° angular interval around the center of the contactor 2, to become four in total.

A characteristic configuration of the movable contact 1 for switching according to the invention is to form recesses 7 for use in prevention of deformation, on a convex side face of the bulge 5, by depressing a part of the circumference of the bulge 5 in the arc-like shape, on a straight line connecting the center of the bulge 5 with each of the contact points 6, i.e. on a line of the radius, toward the center. A concave side face on the area of the recess 7 serves as an extension surface of the convex surface 4. There are formed four recesses 7 in total corresponding to the positions of the contact points 6 so as to prevent the bulge 5 from being deformed in flat when the bulge 5 receives an external force, and the recesses 7 each are formed in the shape of an angle as well as an arc.

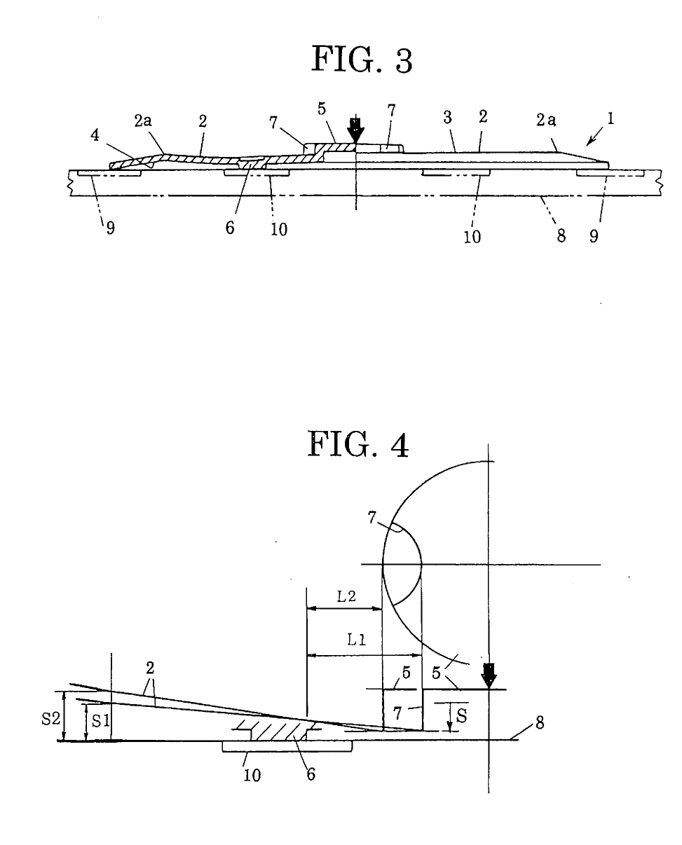

As shown in imaginary lines in FIG. 2 and FIG. 3, the movable contact 1 for switching is built in a switch substrate 8 of a cell phone and so forth so as to face the switch substrate 8. In a state where the movable contact 1 for switching is built in the switch substrate 8, the concave surface 4 of the contactor 2 is always electrically brought into contact with a contact face 9 of the switch substrate 8 at the outer peripheral end thereof, and contact points 6 of the contactor 2 face fixed contacts 10 of the switch substrate 8 while being apart from the switch substrate 8.

In the case where a large force is applied to the bulge 5 of the movable contact 1 for switching in the direction of an arrow in FIG. 3 at the time of execution of a high load test or a switch operation, the dome-shaped contactor 2 receives the large force at this time, to be elastically deformed to approach the switch substrate 8 at the central portion thereof when clicking. As a result, the contact points 6 are forced to be brought into contact with the fixed contacts 10 while the contactor 2 keeps in contact with the contact face 9 of the switch substrate 8 at the outer peripheral end of the concave surface 4, thereby rendering the contact face 9 and the fixed contacts 10 to be in electrically conductive state.

Meanwhile, provided that the contact points 6 are formed at 90° angular interval around the center of the contactor 2, if a load or a force is not applied perpendicularly to an apex surface of the bulge 5, or the load or the force is applied to a position eccentric relative the center of the contactor 2, four contact points 6 are brought into contact with the fixed contacts 10 so that the movable contact 1 for switching is finally rendered in a state to be planarly in parallel with the switch substrate 8, thereby rendering the contact face 9 and the fixed contacts 10 in a conductive state with certainty.

When a high load or a large force is applied to the bulge 5 of the movable contact 1 for switching in the direction of the arrow in FIG. 3, the bulge 5 receives a force in a radial direction from the points where the high load or the large force is applied, so that it is liable to be deformed in flat. However, the outer circumference of the bulge 5 is not a concentric circle but has the recesses 7, so that the force in a radial direction is dispersed at the positions of the recesses 7. Accordingly, the force in a radial direction becomes weak as a force for rendering the dome-shaped contactor 2 to be deformed in flat. As a result, the recesses 7 of the bulge 5 operate to prevent the bulge 5 from being deformed, and also restrain the contactor 2 from being deformed in flat.

If the load or the force is no longer applied to the bulge 5 of the movable contact 1 for switching in the direction of the arrow in FIG. 3, the dome-shaped contactor 2 is recovered to an original state owing to elasticity of the conductive leaf material caused by clicking, thereby rendering the contact face 9 and the fixed contacts 10 to be in an electrically nonconductive state.

FIG. 4 shows, as a diagrammatic view, an operation and an effect of each recess 7 on a straight line connecting the center of the bulge 5 with each of the contact points 6, while comparing each recess 7 provided in the bulge 5 with each recess 7 not provided in the bulge 5. In FIG. 4, according to the movable contact 1 for switching of the invention, a distance L1 on a straight line ranging from an outer circumference of the bulge 5, namely, from the innermost part of the recesses 7 to the contact points 6 is longer than a distance L2 on a straight line ranging from an outer circumference of the bulge 5 to the contact points 6, the bulge 5 having the same size as that provided with no recesses 7. Accordingly, when the bulge 5 is moved by a displacement S in the direction of the switch substrate 8 when the lower edge of the bulge 5 receives a load or a force, the contactor 2 is located at the displacement S1 at an outer peripheral position outside the contact points 6 serving as fulcrums according to the movable contact 1 for switching of the invention while the contactor 2 is positioned at the displacement S2 at the same position according to the movable contact 1 for switching having no recesses 7 wherein the displacement S2 is larger than the displacement S1 so that the contactor 2 is liable to enter an area where the contactor 2 is not reversely recoverable.

Meanwhile, if the outer shape of the bulge 5 is small in the example where the bulge 5 has no recess 7, the distance L2 ranging from an outer circumference of the bulge 5 to the contact points 6, is made equal to or smaller than the distance L1 ranging from an outer circumference of the bulge 5, namely, from the innermost part of the recesses 7 to the contact points 6. However, if an outer shape of the bulge 5 is small, a necessary and sufficient rigidity is not obtained at the central portion of the contactor 2 so that the outer shape of the bulge 5 has to have a size to secure a sufficient rigidity. From the standpoint of the foregoing description, it is also considered that each recess 7 is provided to enlarge the distance L1 ranging from an outer circumference of the bulge 5, namely, from the innermost part of the recesses 7 to the contact points 6 on the radius line of the contactor 2 passing through the contact points 6 accompanied by rendering the bulge 5 to have a necessary size so as to secure rigidity at the central portion of the contactor 2.

According to the movable contact 1 for switching of the invention, it is possible to restrain the contactor 2 from being deformed at an outer peripheral area outside the contact points 6 while contact points 6 each serve as fulcrums when the contactor 2 is elastically deformed, so that the poor recovery caused by a reverse operation of the contactor 2 beyond necessity can be avoided in advance.

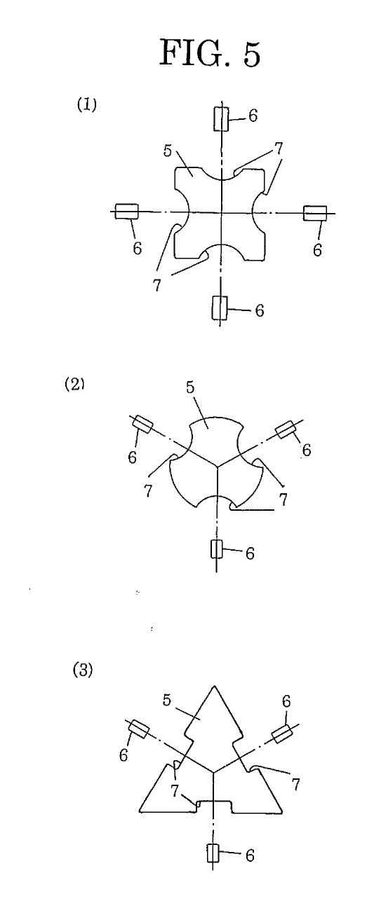

FIGS. 5(1) to 5(3) show a bulge 5 and recesses 7 of the movable contact 1 for switching according to another embodiment of the invention. FIG. 5(1) shows an embodiment wherein the bulge 5 is square and the recesses 7 are formed on each side of the square at 90° angular interval around the center thereof, to become four in total. FIG. 5(2) shows an embodiment wherein the bulge 5 is circular and the recesses 7 are formed at 120° angular interval around the center thereof, to become three in total. FIG. 5(3) shows an embodiment wherein the bulge 5 is triangle and pyramidal recesses 7 and contact points 6 are rendered to correspond to each side of the triangle to become three in total.

Even if the contact points 6 are formed at 120° angular interval around the center thereof as shown in FIGS. 5(2) and 5(3), if a load or a force is not applied perpendicularly to an apex surface of the bulge 5, or the load or the force is applied to a position eccentric relative the center of the contactor 2, three contact points 6 are brought into contact with the fixed contacts 10 so that the movable contact 1 for switching is finally rendered in a state to be planarly in parallel with the switch substrate 8, thereby rendering the contact face 9 and the fixed contacts 10 in a conductive state with certainty. A stability of the three contact points 6 at the time of contact between the contact face 9 and the fixed contacts 10 is greater than that of four contact points 6.

According to the movable contact 1 for switching of the invention, there are peculiar advantages in that if a high load or a large force is applied to the bulge, the high load or a large force is dispersed by the recess 7, so that a large deformation such that the contactor bulges outward is reduced, and the contactor is restrained from being deformed beyond necessity at the peripheral area outside the contact points at the time of elastic deformation of the contactor, thereby avoiding in advance the poor recovery caused by a reverse operation of the contactor beyond necessity.

The bulge can flexibly deal with the change of an outer shape of the contactor in the shape of a circle, an ellipse, a rectangle, a polygon, and so forth. Further dispersion of a force applied to the bulge can be effectively implemented by providing recesses of an arc-like shape or a pyramid-like shape. Since total three to four pieces of the contact points and the recesses, respectively, are formed at equal angular intervals around the center of the contactor, the elastic deformation of the contactor is stabilized even against an eccentric load/force and a load/force other than a vertical load, thereby ensuring the switch operation.

The movable contact 1 for switching according to the invention is widely used as a push switch for various electrical equipments, e.g. an audio equipment, a video equipment, a communication equipment, a measuring device, other electric equipments, and for an optical equipment such as a camera and also used as a switch of a thin sheet-like shape by attaching a pressure-sensitive adhesive sheet to a switch substrate 8 of a cell phone, and so forth.

While the present invention has been shown and described with reference to certain exemplary embodiments thereof, other implementations are within the scope of the claims. It will be understood by those skilled in the art that various changes in form and details may be made therein without departing from the spirit and scope of the invention as defined by the appended claims.

What is claimed is:

1. A movable contact for switching comprising:
a reversely recoverable contactor formed by curving an electrically conductive leaf material into a dome-like shape while forming a bulge at the center of a convex surface of the contactor, the bulge for addition of rigidity, protruding toward a dome-shaped convex side;
a plurality of contact points formed by forming small projections concentrically positioned around the bulge, on a concave surface of the contactor, the small projections protruding toward a dome-shaped concave side; and
a recess for use in prevention of deformation, on a convex side face of the bulge, formed by depressing a part of the circumference of the bulge, on a straight line connecting the center of the bulge with each of the contact points, toward the center.

2. The movable contact for switching, according to claim 1, wherein the bulge is formed in any one shape selected from the group consisting of a circle, an ellipse, a rectangle, and a polygon.

3. The movable contact for switching, according to claim 1, wherein the recess is formed in the shape of an arc, or a square.

4. The movable contact for switching, according to claim 1, wherein total three to four pieces of the contact points 6, and the recesses, respectively, are formed at equal angular intervals around the center of the contactor.
